(19) United States
(12) Patent Application Publication
(10) Pub. No.: US 2002/0052893 A1
(43) Pub. Date: May 2, 2002

(54) Method and system for importing and exporting table data

(76) Inventors: Dirk Grobler, Neumunster (DE); Ocke Janssen, Hamburg (DE)

Correspondence Address: Forrest Gunnison, Gunnison, McKay & Hodgson, L.L.P, 1900 Garden Road, Suite 220, Monterey, CA, 93940, US

(21) Appl. No.: 09/738,488

(22) Filed: Dec. 13, 2000

(30) Foreign Application Priority Data
Dec. 14, 1999 (EP) 99124942.6

(51) Int. Cl. G06F 15/00

(52) U.S. Cl. 707/509; 707/504

(57) ABSTRACT

A computer based method imports table data from a selected source document into a selected target document. The source document is at least partly written in a tag language and the target document is in a format accessible by a database software application. The method includes: temporarily storing data of a selected source; analyzing the table structure of the temporarily stored source data; and generating a target table in accordance with the table structure of the source data.

### BACKGROUND OF THE INVENTION

1. Field of the Invention

The present invention relates generally to a method for the import and export of table data into a database, and more particularly to the import and export of table data the format of which is in accordance with a tag language into or from a table of a database.

2. Description of Related Art

Presently used personal computers very often not only have installed thereon software for the purpose of word processing, but also some kind of database software. Moreover, due to the enormous growth of the Internet many personal computers are provided with equipment, which enables them to connect to the Internet. Typically, this equipment includes a modem and some kind of communication software that enables the user to connect the computer to a server, to access Internet pages and to display the Internet pages using browser software running on the computer.

Such Internet pages usually are written in HTML, which is a so-called tag language. Such tag languages use plain text commands preceding the content to be displayed to indicate the format in which the content should be displayed. Those commands, which are called tags, are interpreted by software, such as a browser, and based on the interpretation, the browser displays the content of the document in accordance with the commands given by the tags.

The tags may, for example, cause the browser to display the content of a document in the form of a table. In this case, the content is displayed in columns and rows in accordance with the tag commands.

Another tool for displaying, editing, and querying tables is database software. Database software operates on documents, which are stored and displayed as tables. The tables can be queried, for example, by using the structured query language (SQL), the contents of a document can be filtered, or the like. The tables, in which data are stored in rows and columns and which are accessed by database software, are in accordance with a certain format, which depends on the database software being used.

When in the following reference is made to the format of some data, this is to be understood in a broad sense, which means that term format may refer to any aspect in which the data is organized. Those aspects may include, for example, the conventions on which parts in a sequence of data are to be interpreted as commands or instructions, how these commands should look, and on the other hand, which data of the sequence are to be regarded as user data or contents. Format may also refer, for example, to the attributes defining the content of a table in terms of the content's style, the number of characters in the content, or the like. Hence, the term “format” just means that there is some defined way of how data is organized and how data is to be interpreted.

Referring for example to “data in the HTML format” means that this data has tags preceding the data or “contents” in accordance with the conventions of HTML. Similarly the term “data in the rich text format” refers to data where—like in the HTML format—the data or “contents” are anteceded by some tags, however, by tags different than the ones of HTML.

To the contrary, when in the following reference is made to the term “structure”, structure refers to the way some data is organized in columns and rows. In other words, structure refers to the structure of a table in terms of how the table is organized in columns and rows.

The term “format of a table” therefore has in the following a slightly different meaning compared to the term “structure of a table”. While the former may refer to any of the aspects of how the table data is organized, including its organization into columns and rows, the latter merely refers to the actual table structure in the sense of “where are the columns, where are the rows, how many of them do we have”, and the like.

Since the formats of documents on which commonly available database software operates are different from the format of tag languages such as HTML, at present there is no possibility to facilitate an easy exchange of data between documents written in a tag language, such as HTML, and documents, which are written in a format which is in accordance with some database software.

There exist some HTML drivers based on the Open Database Connectivity (ODBC), which provides a kind of standard to which all manufacturers of database software have committed themselves. With such an ODBC driver for HTML, database software is able to access a table written in HTML and to produce a database view onto this document. This means that the database software using such an ODBC driver can access HTML documents as if they were written in the format of documents usually accessed by this database software, and by using the driver the database software can display those HTML documents in a view as if the documents were files containing tables in the format provided and required by the database software.

This, however, only enables a user to view the content of a HTML file as if the user would a database file. The user cannot, however, actually import the HTML table into a table of the user's database software.

Moreover, using such an ODBC driver only enables the user to access a file written in HTML by the user's database software. The user cannot exchange data between documents created using the user's database software and another software application running on the user's computer and presently accessing a HTML file.

It may happen, for example, that the user of a personal computer wishes to transfer some data, which is displayed by the browser, into a file or a table for access by the database software running on the user's computer. This can for example be the case if when surfing the Internet, the user encounters some particularly interesting statistics or tables displayed on a certain website, which the user wishes to copy into a file for access by the user's database software, or to have the data stored for further processing or combination with other data in the database, etc.

With the software presently available for personal computers, it is not possible to copy or to import such data in an easy and user-friendly manner, and vice versa, it is not possible to export data from a database table into a HTML file or document. Rather than providing such import and export capabilities, the presently available software only provides the user with a “database view” onto a HTML document.

### SUMMARY OF THE INVENTION

One embodiment of the present invention provides a computer user a tool for carrying out the import of data into and the export of data from a database table, where the database table is in accordance with the format given by a database software application, and where the exported or imported data has a format which is in accordance with a so-called tag language, such as HTML or RTF (Rich Text Format). This tool is a method for importing table data, which is in a tag language format, such as HTML, into the table of a database file of a database software application. This is accomplished by selecting table data of the source to be imported and the target of the import, by temporarily storing the table data of the selected source, analyzing the table structure of the temporarily stored table data, and by finally generating a target table in accordance with the table structure of the source data and the format requirements of the database software application.

Selecting the table data of the source can be carried out by selecting a source file using a mouse and the cursor, or by selecting some part of a source document using the mouse and the cursor or the keyboard, to thereby copy the selected part into a clipboard. The transfer of the table data from the source into the target file or the target document may also be carried out by using the mouse and the cursor, either by a drag-and-drop process to drag the selected table data into the target location and to drop it there, or by using the copy and paste functions provided by the clipboard.

To adapt or to convert the source table data format (including the table structure of the source) to the format of the target document, a conversion is performed which recognizes the tags of the tag language, identifies some elements of the source document as table elements, analyzes the table structure of the source document to identify the columns and rows of the table as well as their content (the table fields or elements), then extracts the content of the table elements, and finally inserts those contents into an empty target data structure of the database software application which in its (table) structure is in accordance with the table structure of the source data as obtained from the analysis of the format of the source document.

A similar process may also be carried out in the opposite direction, in this case the user may select some data from a database file or a database table, this data is then dragged and dropped into a HTML file or a HTML document, or it is moved thereto by means of the clipboard functions. In this case a format conversion takes place; however, rather than extracting the tags of the tag language, the conversion generates tags, which provide a table structure in accordance with the structure of the table from which the source data was selected.

Thus, in an embodiment of the present invention, the user can import and export table data to and from a database file or a database table in a very easy and convenient manner. Using the drag-and-drop function or the copy and paste clipboard function makes it very easy for the user to integrate HTML table data into the user's database tables accessed by the user's database software. Similarly, the user can easily export data from tables of the user's database into HTML documents to make use of tables the user has created with the user's database software when for example designing a new web page.

In another embodiment of the present invention, the user can import and export any table data written in a tag language into and from the table of a database. This embodiment provides an easy and convenient tool for exchanging data between a source document and a target document, where the source document is written in a tag language and the target document is in a format in accordance with the requirements of a database software, or vice versa. Not only whole documents but also parts of documents can be imported and exported, even between documents which at the same time are accessed by different application programs, such as a table accessed by a database software application and a web page accessed by a web browser.

### BRIEF DESCRIPTION OF THE DRAWINGS

FIG. 1 schematically shows a configuration of a computer system to be used in accordance with one embodiment of the present invention.

FIG. 2 shows an initial window of a software tool in accordance with one embodiment of the present invention.

FIG. 3 shows a window in which a target for an import process has been selected in accordance with one embodiment of the present invention.

FIG. 4 shows a window offering user settings in accordance with one embodiment of the invention.

FIG. 5 shows a further window for inputting user settings in accordance with one embodiment of the invention.

FIG. 6 shows the result of an input process in accordance with one embodiment of the present invention.

FIG. 7 shows a schematic illustration of a software tool interacting with a source and a target in accordance with one embodiment of the present invention.

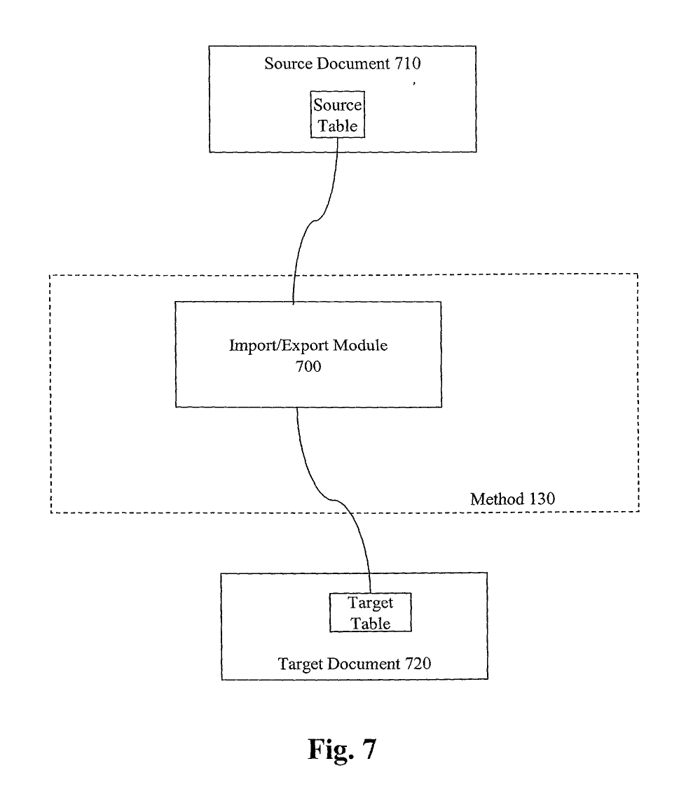

FIG. 8 schematically shows the components of a software tool for data import in accordance with one embodiment of the present invention.

FIG. 9 shows components of a software tool for data export in accordance with one embodiment of the present invention.

### DETAILED DESCRIPTION

In an embodiment of the present invention, with a method 130, a user of a computer system 100, such as a personal computer, can import tag formatted table data into a database table, and export data from a database table into a tag formatted table. In each case, the database table has a format given by a database software application 111, sometimes called database application 111. The tag formatted table and table data have a format, which is in accordance with a so-called tag language, such as HTML (HyperText Markup Language) or RTF (Rich Text Format).

The user imports and exports the data using only information viewed on a display screen 195 of a monitor 116 of computer system 100, in one embodiment. In particular, no computer programming capability is required of the user. Accordingly, the user can use method 130 of this invention with any device that has a display and the input capability described more completely below.

To import table data, which is in a tag language format, such as HTML, into a table of a database file of database application 111, the user first selects a source of the table data to be imported, and selects a target of the import. Selecting the source table data can be carried out by selecting a source file using mouse 118 and a cursor, or by selecting some part of a source document using mouse 118 and the cursor or by keyboard 119, to thereby copy the selected part into a clipboard provided by operating system 114.

The transfer of the source data into the target file or the target document may also be carried out by using mouse 118 and the cursor, either by a drag-and-drop process to drag the selected passage into the target location and to drop it there, or by using the copy and paste functions provided by the clipboard. In either case, in one embodiment, method 130 takes the source table data, analyses the data, creates a database application table, and populates the database application table with some or all of the source table data.

Method 130 provides the personal computer user with a capability to import and export table data to and from a database file or a database table in a very easy and convenient manner. Using the drag-and-drop function or the copy and paste clipboard function makes it very easy for the user to integrate HTML table data into the user's database tables that can accessed by the user's database software, e.g., database application 111. Similarly, the user can easily export data from tables of the user's database into HTML documents to make use of tables the user has created with database application 111 when for example designing a new web page.

Method 130 also provides the user with the capability to import and export any table data written in a tag language into and from the table of a database. Thus, the user has an easy and convenient tool for exchanging data between a source document and a target document, where the source document is written in a tag language and the target document is in a format in accordance with the requirements of a database software, or vice versa. Not only whole documents but also parts of documents can be imported and exported, even between documents, which at the same time are accessed by different application programs, such as a table accessed by database application 111, and a web page accessed by a web browser, e.g., a tag language application 112. While viewing an Internet page using application 112, and at the same time accessing a database table using database application 111, the user can exchange table data between the web page and the database document just by using a drag-and-drop operation or the copy and paste function of the clipboard.

In one embodiment, database application 111 is a software program, which is used for creating, editing, displaying, modifying, and querying data stored in databases, which are in accordance with some data format depending on the database software program used. The database tables have a table structure, which means that the data contained in a database table are arranged in columns and rows. An example of such a database software application 111 is the StarBase database application of the STAROFFICE software package of Sun Microsystems, Palo Alto, Calif. (STAROFFICE is a trademark of Sun Microsystems.)

Tag language application 112 is any software program, which is capable of accessing and handling files written in a so-called tag language, such as HTML. Tag languages use commands called tags, which indicate the format of the data following the tag, or which define the action to be taken in connection with the data following a tag. For example, tag <FONT> defines the font to be used in connection with the data, which follows the tag when displaying the data. Another example of such a tag language is the rich text format .(RTF), which gives information on formats also by commands or tags being located in front of the data. Tag language application program 112 may be, for example, any browser capable of processing HTML files, such as the Internet Explorer browser produced by Microsoft Corporation, or the Netscape Communicator browser produced by Netscape Inc.

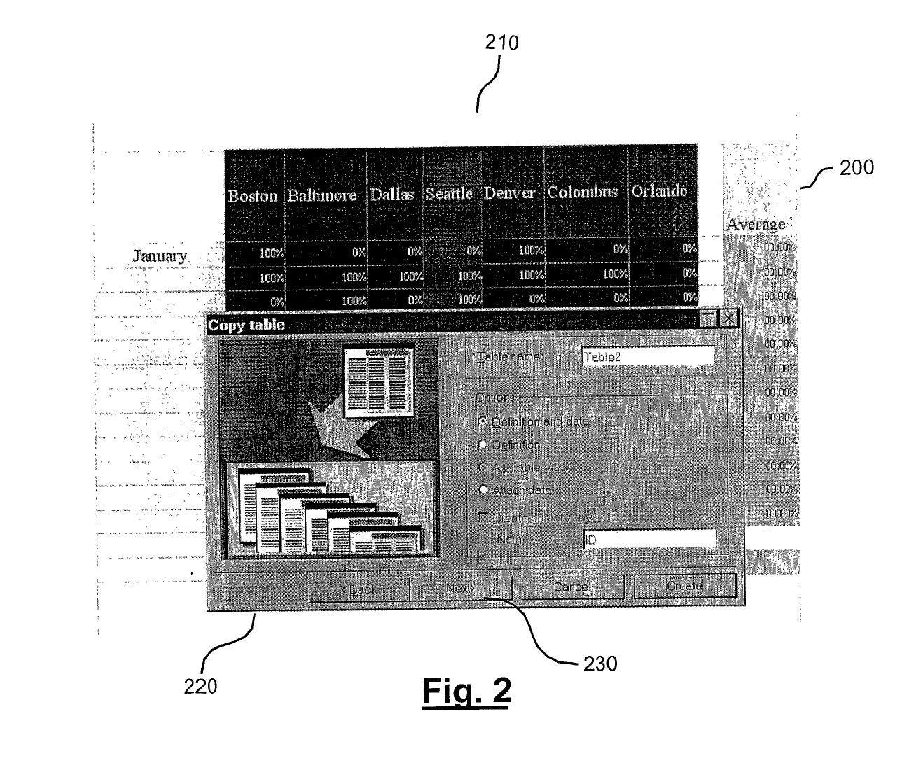

In an embodiment, the user simultaneously uses database application 110 and an Internet browser 112. A document displayed by browser 112 contains a table 200 (FIG. 2). The source document of table 200, and consequently table 200, is written in the HTML format.

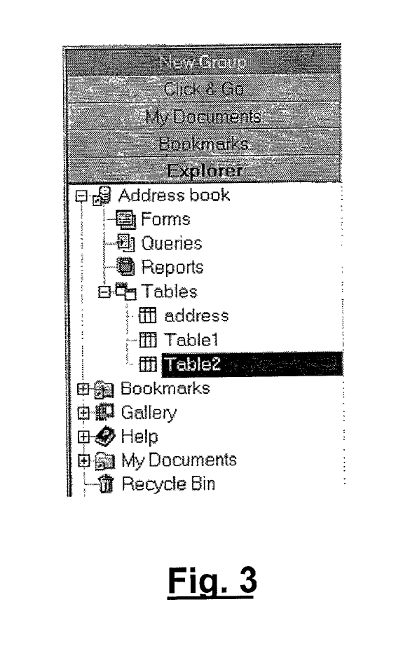

To import a part of table 200 into a file or a table of database application 111, the user selects a part 210 of the table, which is then highlighted on the display, using one or more of the input devices of computer system 100, e.g., mouse 118. While holding the shift button and using the drag-and-drop function, the user drags selected part 210 into a target file or a target folder, for example into the file “Table 2” as shown in FIG. 3. In one embodiment, the target file “Table 2” is a table container of the STAROFFICE software package.

After the user has dragged and dropped selected part 210 into target file “Table 2,” e.g., temporarily stored selected part 210, a pop-up window 220 of a wizard dialogue comes up on monitor 116. As explained below, the wizard dialogue provides the user with further possibilities to select the manner in which selected part 210 is imported into the target table of database application 111.

In pop-up window 220, the user can specify the table name. The user is also provided with several other choices that include definition and data, definition, attach data, and create primary key. The choice between definition and data and definition allows the user to decide whether the definition of the source data table as well as the source table data or whether only the definition of the source data table is to be imported into the target table.

If definition and data are selected, the table structure of the selected table data as well as the content of the table of the selected part of the HTML source document are copied into the target table. If only definition is selected in pop-up window 220, only the table format (the table structure) of selected table data 210, referred to above as selected part 210, is copied into the target table, in other words: an empty target table is created with a table structure in accordance with the table structure of selected table data 210.

If the user selects option Attach data in window 220, selected table data 210 are attached to the target table, which means that the selected source table data are appended to a table already present in the target table.

If the user selects option Create primary key in window 220, a primary key is created, which means that for each row of selected table data 210 a primary key field is created and is filled out automatically. A primary key uniquely identifies a certain row (a dataset) in a database table. This is particularly useful when a table is being copied from a document not containing a primary key into a database file of a database application, which requires such a primary key for further editing of the target document.

To carry out the import of selected table data 210, the selected table data of the source document is analyzed by method 130 to recognize the individual rows and columns of selected table data 210. This is done by identifying the tags in the source document to distinguish between data indicating the table format or the table structure, and on the other hand data forming the content of the table. Thereby, the individual entries of the data fields of selected table data 210 can be recognized, as well as to which column and to which row of selected table data 210 the entries belong.

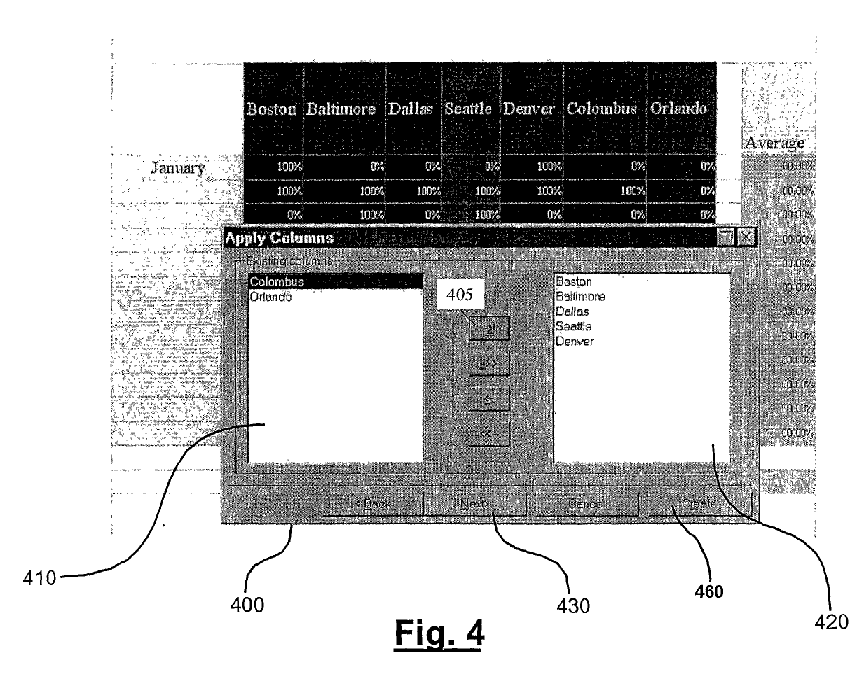

By clicking button “next” 230 of window 220 the user reaches a second window 400 (FIG. 4), an apply columns window, of the wizard dialogue. In window 410 within window 400, which is labeled “Existing columns,” the columns of table 210 are listed. By selecting an entry, e.g., entry “Columbus,” in window 410 and clicking on to button (→) 405 between windows 410 and 420 of window 400, the user select the columns, which are to be imported into the target table. The selected columns are shown in window 420 of window 400.

In the example shown in FIG. 4, the user, at this time, has selected columns Boston, Baltimore, Dallas, Seattle, and Denver to be imported into the target table.

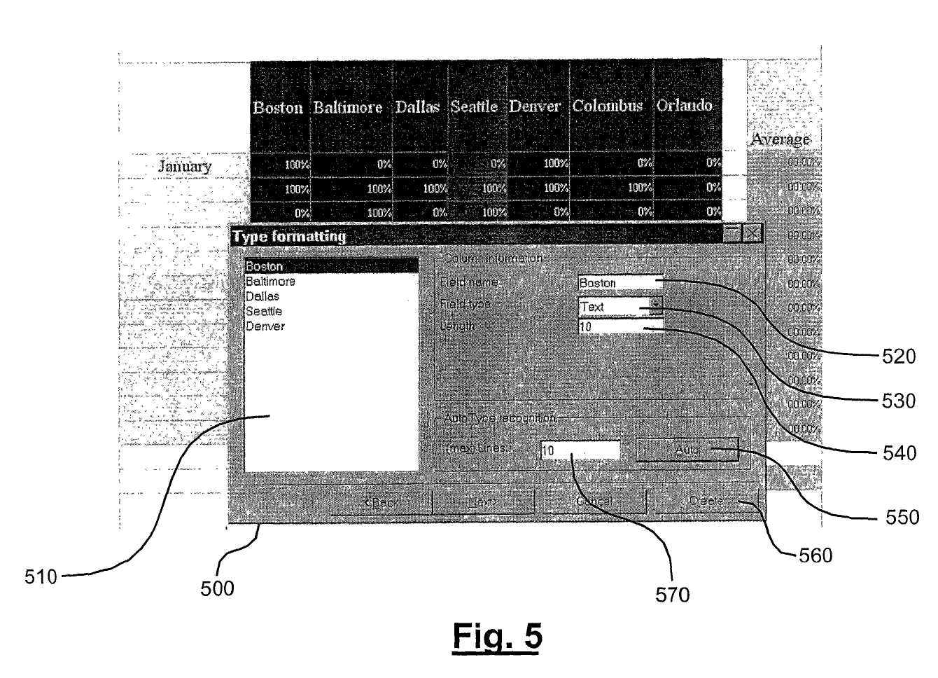

By clicking on button “Next” 430 of window 400, the user reaches a third window of the wizard dialogue, e.g., a type formatting window, which is shown as window 500 in FIG. 5. Therein, the user can make selections regarding the format of the individual columns selected in window 400.

However, if the user does not wish to make any changes to the format of the individual columns, the user can click on button Create 460. In this case all the selected columns are adopted as text fields with a length of 255 characters as the default.

Assuming the user clicked button 430 in window 400, in window 510 of window 500, the headers of the selected columns are listed. The user can, by a mouse click, select one of them and can choose or adjust column information regarding the format displayed in a field name window 520, a field type window 530, and a length of field window 540. By editing the field name in field name window 520, the user can amend the name shown therein. By using the pull-down menu of field type window 530, the user may amend the field type of the column. In window 540, the user can edit the length of the field of the column belonging, to the column header, which presently is selected in window 510 of the window 500.

By clicking button 550, the user starts an automatic type recognition carried out on selected source table data 210. In this case, an automatic type recognition process is executed for a number of lines of the selected table data as specified in max lines window 570. If, as chosen in the example shown in FIG. 5, ten lines are selected, the automatic type recognition process is run for ten rows of selected table data 210.

The automatic type recognition process recognizes different data types, such as text data, numbers, percentages, or the like. If no consistent type recognition can be carried out, for the columns where some inconsistency arises, field type text is selected.

After the user made the selections in window 500, the user clicks on button Create 560. The response to the user clicking on button Create 460 or button Create 560 is the same. Method 130 creates a table structure in the target document, which is in accordance with the user's selections. If the user in window 220 chose the option “definition and data”, the created table structure is filled with the contents of the individual data fields in the selected columns of selected data table 210. If the user has chosen only the option “definition”, an empty table structure is created.

If the user selected a folder as the target, within this folder a new target document is created into which the imported source table data is written. If the target selected by the user is a file or an already opened document or table, a target table, into which the imported source table data is written, is created in this file, document, or table, respectively.

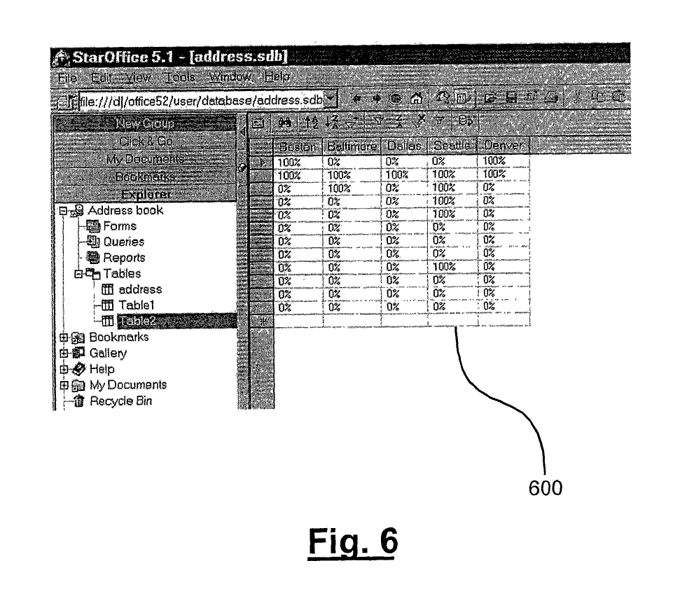

FIG. 6 shows the target document into which the table has been imported in accordance with the selections made by the user, as described above. Table 600 is a display of a database table as seen by the user when displayed by database application 111. Table 600 is in a format as required by database application 111 that is displaying the table. Table 600 is the target document or the target table into which the table data from the HTML source document has been imported by the procedure described before. As chosen by the second page 400 of the wizard dialogue, table 600 now contains columns Boston, Baltimore, Dallas, Seattle, and Denver.

If creation of a primary key had been selected, table 600 would also contain a further column with the primary keys of the individual rows of table 600 assuming the option to display the table with the primary key was selected by database application 111. If the option to display the primary key was not selected, the displayed table would look as shown in FIG. 6.

The import procedure, as described above, is performed by a software import/export module 700 within method 130. Execution of import/export module 700 imports data from a source table in a source document 710 into a target table in a target document 720. It will be understood by those skilled in the art that the operations and actions carried out by import/export module 700 represent, in one embodiment, actions performed by CPU 101 of computer system 100 in accordance with computer instructions of module 700. The operation of the import/export module 700 is described in more detail herein below.

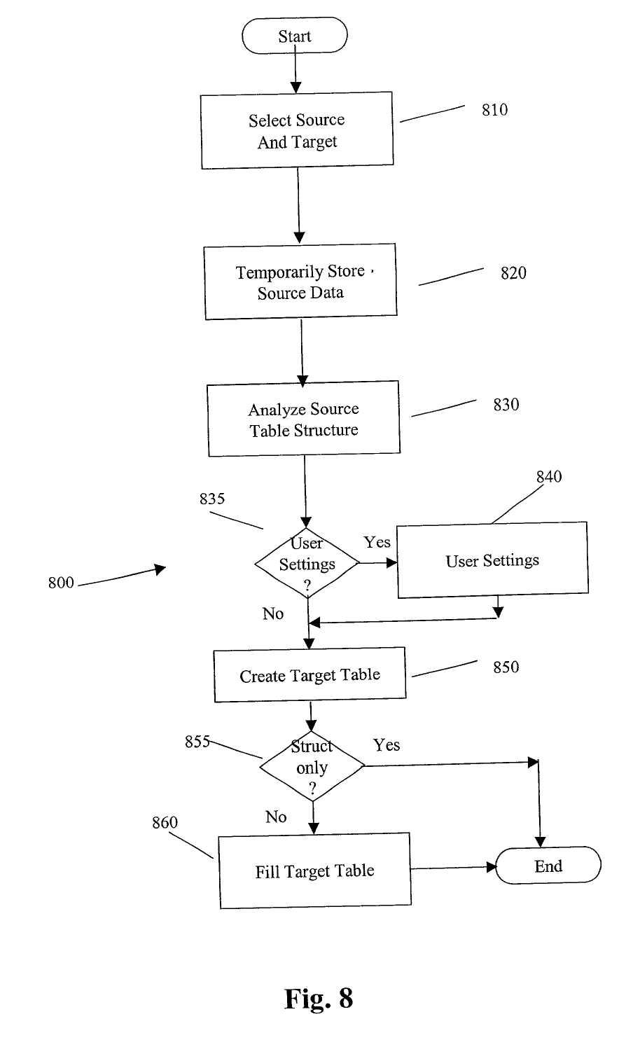

A first sequence of operations of module 700 is described in connection with an import process 800, as illustrated in FIG. 8, where table data from a HTML file is imported into a table accessible by database application 111. In select source and target operation 810, the source and the target of the import are selected.

In an embodiment, the selections in operation 810 are made using either a drag-and-drop function provided by operating system 114 of computer system 100, or by a clipboard function provided by operating system 114. These functions enable the user to select a source and a target of the import process by using mouse 118 or keyboard 119. The source may either be a source document, a part of a source document, or a folder from which source table data is to be imported. Similarly, the target may either be a folder, a file (a document) or a certain location in a file (a document).

After the source and target of the import process have been selected in operation 810, the source data selected in operation 810 is handed over to and temporarily stored in temporarily store source data operation 820.

Next, analyze source table structure operation 830 analyzes the table structure of the temporarily stored source data. Operation 830 parses the source data for tags, which indicate the table structure of the source data. The parsing process analyzes the table structure of the source data to identify the individual columns and rows contained in the source data, as well as to identify the contents of the columns and rows of the source data.

In case of the source table being in the HTML format, the source first is parsed for the tag <table>indicating the start of a table. Corresponding tags indicate the individual fields of a row of the table. The headers of the individual columns (the descriptors of the columns) are delimited by a tag <TH> indicating the start of a table header (a column descriptor) and by a tag </TH> indicating the end of a table header (a column descriptor). The table header “Boston” has the form <TH>Boston</TH>. A sequence of table headers in this manner indicates the column descriptors as the first row of a table.

Individual rows of a table are indicated by a tags <tr> indicating the start of a row and a tag </tr> indicating the end of a row. Cells or fields of a row, which are not column headers, are delimited by a tag <td> indicating the start of a cell and by a tag </td> indicating the end of a cell. The table field “John Smith” would then have the form <td> John Smith </td>. The individual cells are grouped into rows of the table by the tags <tr> and </tr>. Between those two tags several fields may be inserted, each field being indicated by the tag pair <td> and </td>, as explained before. In this manner, the table may be formed by a sequence of several rows. After the last row of the table is the table end tag </table>.

Thus, in operation 830, when analyzing source table data, the parser looks for the commands or tags indicating the individual cells or fields and the individual rows of a table. This provides information on how the table is structured into columns and rows. The same principle applies for any other tag language where tags, which may look different than the ones of the example explained before, but which perform a similar function, indicate the structure of the table.

After the table of the source data has been analyzed by operation 830, user setting check operation 835 determines whether the user selected to specify the format of the target table. If the user made such a selection, processing transfers to user settings operation 840 and otherwise to create target table operation 850.

User settings operation 840 offers the user the opportunity to specify the characteristics of the target table. In one embodiment, the user can choose which source table columns recognized by module 830 actually are imported in the target table. The user can choose or modify data contained in the individual columns, the length of the data, and the like. The user may also choose whether the imported data is to be attached to a table already present in the target document, or whether a new target table should be created. The user may also choose performance of an automatic type recognition to create a target structure in accordance with the automatic type recognition. Each of these options was described more completely above.

Upon completion of user settings operation 840, processing also transfers to create target table operation 850. Operation 850 creates an empty target table, the structure of which is in accordance with the results obtained by operation 830 and in accordance with the settings chosen by the user through operation 840. The format of the empty target table created by operation 850 also is in accordance with the requirements of the database application 111 so that database application 111 can access the empty target table.

After operation 850 is completed, structure only check operation 855 determines whether the user selected to only create an empty target table having the structure of the source data table, or to populate the target table with the data in the columns selected from the source data table. If the user selected only to create an empty table, process 800 is complete and so check operation 855 transfers to the end operation. Conversely, if the user elected to populate the target table with data, check operation transfers to fill target table operation 860.

Operation 860 fills the empty target table with the source data, which means that the contents of the fields of the source table are inserted into the empty target table. The target table filled by operation 860 may either be a new target document/target table, or a table, which is appended to another table already present in the target document selected by the user. If in user settings operation 840, the user has chosen to attach the imported data, the target table is appended or attached to a table already present in the target document or the target table selected by the user in operation 810.

In connection with process 800 (FIG. 8), the import of source data written in a tag language into a target document the format of which is in accordance with the format required by a database software was described. In one embodiment, each of operations 810, 820, 830, 840, 850, and 860 is performed by execution of a different software module. Thus, process 800 includes a plurality of modules in one embodiment. Many of these modules are also used in the export of data from a table of database application 111 to a tag language table, which is the opposite of process 800.

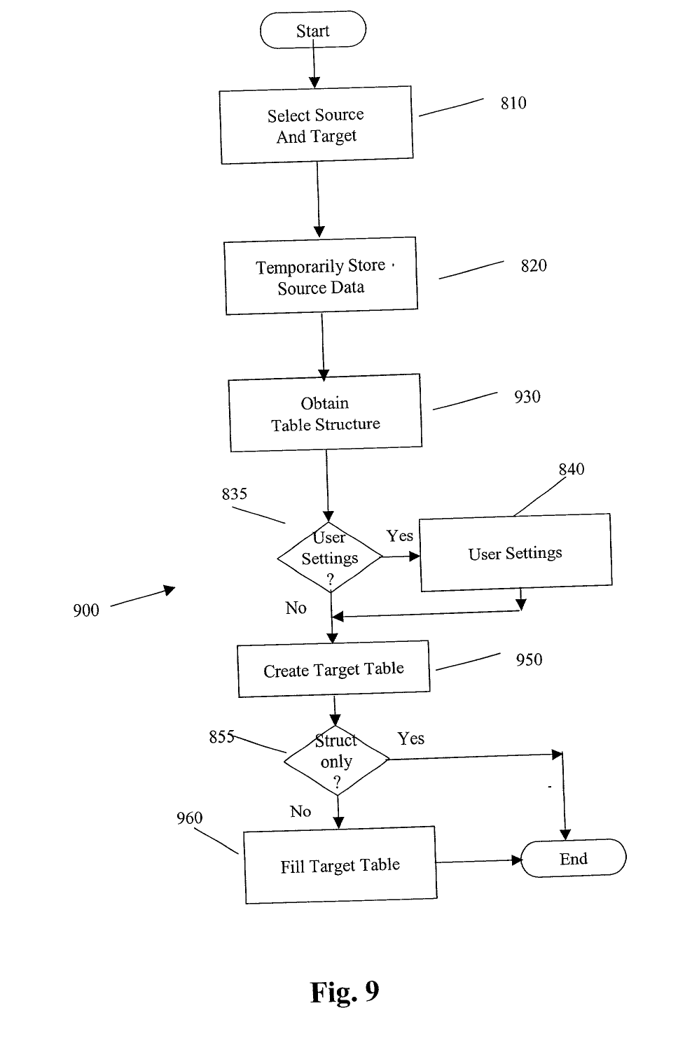

In connection with FIG. 9, an opposite process 900 of exporting data from a database document into a document, which is written in a tag language, such as HTML or the rich text format (RTF) is illustrated. In export process 900, operations 810 and 820 are the same as described for import operation 800, except the source data table is a table associated with database application 111 and the target table is a table formatted in a tag language.

However, in export of the data from a database table, database application 111 already is aware of the structure of the table to be exported, no parsing process, as carried out by operation 830 in import process 800, has to be carried out in export process 900. Hence, obtain table structure operation 930 obtains information about the source table structure from database application 111. This information includes, but is not limited to, the attributes and the type of the data contained in the source table as well as of the structure of the source table.

Like in the case of import process 800, the user has the option of specifying the format of the target table. Accordingly, operations 835 and 840 are used in process 900, and the above description of these operations is incorporated herein by reference.

Create target table operation 950 creates an empty target table based on the table structure obtained from database application 111 through operation 930, and based on the user settings carried out by the user in operation 840. The empty target table is created by generating tag commands, which define a target table structure in accordance with the source table structure and the user settings.

Again, the user can select either to create only an empty target table, or to populate the target table and so structure only check operation 855 performs the same operations as in import process 800.

File target table operation 960 fills the empty target table with the table contents of the source data. This operation inserts the rows of data using the appropriate tags to denote each cell in the row, and each row. This operation also applies any formatting tags for the data needed to implement the user specified settings from operation 840.

As described herein, method 130 of this invention provides the user with an easy and convenient tool for exchanging table data between two documents, one being in a format as required by database application 111, and the other one being written in a tag language. The tag language can either be HTML, the rich text format (RTF), or any other tag language, such as XML, SML, TeX, LaTeX, or the like. The format of the database document may be any format used by a database application to operate on tables or table documents.

Those skilled in the art will readily recognize that the individual operations mentioned before in connection with the procedure of importing and exporting table data according to method 130 can be performed by executing computer program instructions on CPU 101 of computer 100. In another embodiment of the present invention, however, method 130 may also be implemented by dedicated electronic circuits, which are configured such that they perform the individual operations explained before in connection with method 130. In yet another embodiment of the invention, a storage medium has thereon installed computer-executable program code, which causes the CPU of a computer to perform the operations of method 130 explained above.

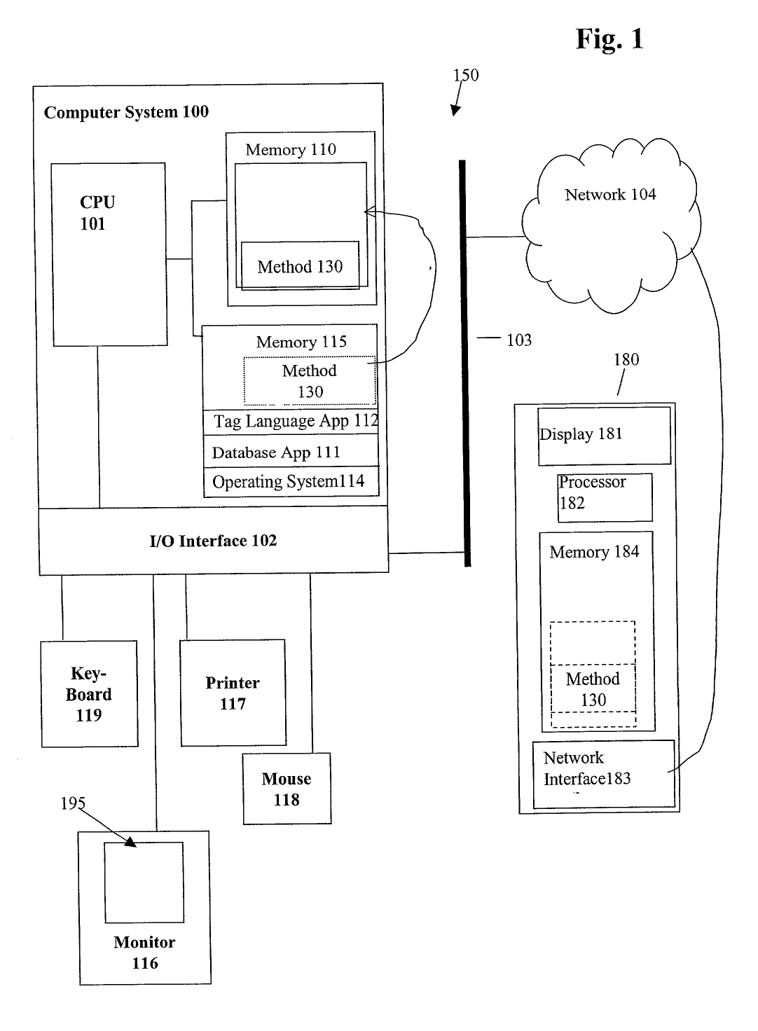

Method 130 can be executed on a hardware configuration like a personal computer or workstation as illustrated schematically in FIG. 1 by computer system 100. Method 130, however, may also be applied to a client-server configuration 150 that also is illustrated in FIG. 1. The source and target documents may be displayed on a display screen of client device 100 while some or all operations of method 130 are carried out on a server computer 180 accessible by client device 100 over a data network 104, or networks 103 and 104, such as the Internet, using a browser application or the like.

Herein, a computer program product comprises a medium configured to store or transport computer readable code for method 130 or in which computer readable code for method 130 is stored. Some examples of computer program products are CD-ROM discs, ROM cards, floppy discs, magnetic tapes, computer hard drives, servers on a network and signals transmitted over a network representing computer readable program code.

As illustrated in FIG. 1, this storage medium may belong to computer system 100 itself. However, the storage medium also may be removed from computer system 100. For example, method 130 may be stored in memory 184 that is physically located in a location different from processor 101. The only requirement is that processor 101 is coupled to the memory containing method 130. This could be accomplished in a client-server system 150, e.g. system 100 is the client and system 180 is the server, or alternatively via a connection to another computer via modems and analog lines, or digital interfaces and a digital carrier line.

For example, memory 184 could be in a World Wide Web portal, while display unit 116 and processor 101 are in a personal digital assistant (PDA), or a wireless telephone, for example. Conversely, the display unit and at least one of the input devices could be in a client computer, a wireless telephone, or a PDA, while the memory and processor are part of a server computer on a wide area network, a local area network, or the Internet.

More specifically, computer system 100, in one embodiment, can be a portable computer, a workstation, a two-way pager, a cellular telephone, a digital wireless telephone, a personal digital assistant, a server computer, an Internet appliance, or any other device that includes the components shown and that can execute method 130, or at least can provide the input instructions to method 130 that is executed on another system. Similarly, in another embodiment, computer system 100 can be comprised of multiple different computers, wireless devices, cellular telephones, digital telephones, two-way pagers, or personal digital assistants, server computers, or any desired combination of these devices that are interconnected to perform method 130, as described herein.

Herein, a computer memory refers to a volatile memory, a non-volatile memory, or a combination of the two in any one of these devices. Similarly, a computer input unit and a display unit refer to the features providing the required functionality to input the information described herein, and to display the information described herein, respectively, in any one of the aforementioned or equivalent devices.

In view of this disclosure, method 130 can be implemented in a wide variety of computer system configurations. In addition, method 130 could be stored as different modules in memories of different devices. For example, method 130 could initially be stored in a server computer 180, and then as necessary, a module of method 130 could be transferred to a client device 100 and executed on client device 100. Consequently, part of method 130 would be executed on server processor 182, and another part of method 130 would be executed on processor 101 of client device 100. In view of this disclosure, those of skill in the art can implement the invention on a wide-variety of physical hardware configurations using an operating system and computer programming language of interest to the user. For example, FIG. 1 shows input devices 119 and 118, but other input devices, such as speech recognition software and/or hardware could be used to input the selections and data for method 130.

In yet another embodiment, method 130 is stored in memory 184 of system 180. Stored method 130 is transferred, over network 104 to memory 111 in system 100. In one embodiment, network interface 183 and I/O interface 102 would include analog modems, digital modems, or a network interface card. If modems are used, network 104 includes a communications network, and method 130 is downloaded via the communications network.

Method 130 of the present invention may be implemented in a computer program including a comprehensive STAROFFICE office application that is available from Sun Microsystems, Inc. of Palo Alto, Calif. (STAROFFICE is a trademark of Sun Microsystems.) Such a computer program may be stored on any common data carrier like, for example, a floppy disk or a compact disc (CD), as well as on any common computer system's storage facilities like hard disks. Therefore, one embodiment of the present invention also relates to a data carrier for storing a computer program for carrying out the inventive method. Another embodiment of the present invention also relates to a method for using a computer system for carrying out the presented inventive method. Yet another embodiment of the present invention further relates to a computer system with a storage medium on which a computer program for carrying out the presented inventive method is stored.

While the present invention hereinbefore has been explained in connection with one embodiment thereof, those skilled in the art will readily recognize that modifications can be made to this embodiment without departing from the spirit and scope of the present invention.

We claim:

1. A method of importing table data from a selected source document into a selected target document, said source document being at least partly written in a tag language and said target document being in a format accessible by a database application, said method comprising:
temporarily storing the,table data from said selected source document;
analyzing the table structure of the temporarily stored table data; and
generating a target table in accordance with the table structure of the source data, and in said format accessible by said database application.

2. The method of claim 1, wherein said method further comprises:
performing said selection of the source and the target documents using a drag-and-drop operation.

3. The method of claim 1, wherein said generating a target table further comprises:
generating said target table in accordance with definitions selected by the user.

4. The method of claim 1, further comprising:
performing an automatic recognition of the format of said table data from said selected source document.

5. The method of claim 1, wherein
said table data from said selected source document is in a format selected from the HTML format and the rich text format (RTF).

6. A method of exporting table data from a selected source document into a selected target document, said source document being in a format accessible by a database application, said target document being at least partly written in a tag language, said method comprising:
temporarily storing the table data from the selected source document;
obtaining the table structure of the temporarily stored table data; and
generating a target table in accordance with the obtained table structure using said tag language.

7. The method of claim 6, wherein said method further comprises:
performing said selection of the source and the target documents using a drag-and-drop operation.

8. The method of claim 6, wherein said generating said target table further comprises:
generating said target table in accordance with definitions selected by the user.

9. The method of claim 6, wherein
said table data from said selected source document is in a format selected from the HTML format and the rich text format (RTF).

10. A computer program product comprising computer program code for a method for importing table data from a selected source document into a selected target document, said source document being at least partly written in a tag language and said target document being in a format accessible by a database application, upon execution of said computer program code, said method comprising:
temporarily storing the table data from said selected source document;
analyzing the table structure of the temporarily stored table data; and
generating a target table in accordance with the table structure of the source data, and in said format accessible by said database application.

11. The computer program product of claim 10, wherein said method further comprises:
performing said selection of the source and the target documents using a drag-and-drop operation.

12. The computer program product of claim 10, wherein said generating said target table further comprises:
generating said target table in accordance with definitions selected by the user.

14. The computer program product of claim 10, said method further comprising:
performing an automatic recognition of the format of said table data from said selected source document.

15. The computer program product of claim 10, wherein
said table data from said selected source document is in a format selected from a HTML format and a rich text format (RTF).

16. A computer program product comprising computer program code for a method of exporting table data from a selected source document into a selected target document, said source document being in a format accessible by a database application, said target document being at least partly written in a tag language, upon execution of said computer program code, said method comprising:
temporarily storing the table data from the selected source document;
obtaining the table structure of the temporarily stored table data; and
generating a target table in accordance with the obtained table structure using said tag language.

17. The computer program product of claim 16, wherein said method further comprises:
performing said selection of the source and the target documents using a drag-and-drop operation.

18. The computer program product of claim 16, wherein said generating said target table further comprises:
generating said target table in accordance with definitions selected by the user.

19. The computer program product of claim 16, wherein
said table data from said selected source document is in a format selected from the HTML format and the rich text format (RTF).

20. A system comprising:
a processor; and
a memory coupled to said processor, and having stored therein computer instructions for a method of importing table data from a selected source document into a selected target document, said source document being at least partly written in a tag language and said target document being in a format accessible by a database application, wherein upon execution of said computer instructions on said processor, said method comprises:
temporarily storing the table data from said selected source document;
analyzing the table structure of the temporarily stored table data; and
generating a target table in accordance with the table structure of the source data, and in said format accessible by said database application.

21. A system comprising:
a processor; and
a memory coupled to said processor, and having stored therein computer instructions for a method of exporting table data from a selected source document into a selected target document, said source document being in a format accessible by a database application, said target document being at least partly written in a tag language, wherein upon execution of said computer instructions on said processor, said method comprises:
temporarily storing the table data from the selected source document;
obtaining the table structure of the temporarily stored table data; and
generating a target table in accordance with the obtained table structure using said tag language.
